(19) United States
(12) Patent Application Publication
(10) Pub. No.: US 2011/0154222 A1
(43) Pub. Date: Jun. 23, 2011

(54) EXTENSIBLE MECHANISM FOR CONVEYING FEATURE CAPABILITIES IN CONVERSATION SYSTEMS

(75) Inventors: Srivatsa Srinivasan, Renton, WA (US); Sundar Anantharaman, Redmond, WA (US); Pradipta Kumar Basu, Redmond, WA (US); Gene Zhang, Redmond, WA (US)

(73) Assignee: Microsoft Corporation, Redmond, WA (US)

(21) Appl. No.: 12/641,689

(22) Filed: Dec. 18, 2009

(51) Int. Cl. G06F 15/16; G06F 3/048

(52) U.S. Cl. 715/753; 709/227

(57) ABSTRACT

Feature capabilities of conversation clients are conveyed to participants in a conversation such that real time decisions can be made and a common set of capabilities are selected to be used in the conversation. User interfaces of participating clients are then adjusted to reflect those capabilities. Further decisions and adjustments may be performed during the conversation in response to changes in participating clients and their capabilities.

### BACKGROUND

Modern communication systems have a large number of capabilities including integration of various communication modalities with different services. For example, instant messaging, voice/video communications, data/application sharing, white-boarding, and other forms of communication may be combined with presence and availability information of subscribers. Such systems may provide subscribers with the enhanced capabilities such as providing instructions to callers for various status categories, alternate contacts, calendar information, and comparable features.

Feature capabilities include high-level end-to-end capabilities of collaborative systems reflected in user interfaces in some manner such as end user features. An example of a user interface feature is a specific control button, a window, or a pop-up menu item. A feature capability is usually associated with a modality (e.g. audio/video, instant messaging (IM), application sharing). These capabilities may change from deployment to deployment. If an end user attempting to interact with another end user is not aware of the feature capabilities of the other end user (e.g. the other end user's client application, device, etc.) the nature of collaboration quality of interaction may be degraded while conflicts due to capability mismatches are resolved.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to conveying feature capabilities of conversation clients to participants in a conversation such that real time decisions can be made and conflicts arising from mismatched feature capabilities can be resolved in two- and multi-party conversations. According to some embodiments, feature capability information may be exchanged through an extensible protocol prior to and during establishment of a conversation.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example unified communications system, where embodiments may be implemented for conveying feature capabilities;

FIG. 2 is a conceptual diagram illustrating a basic example system for a two-party conversation, where feature capability information may be exchanged before and during a communication session;

FIG. 3 is a conceptual diagram illustrating a basic example system for a multi-party conversation, where feature capability information may be exchanged before and during a communication session;

FIG. 4 illustrates architectural stack of major components in a conversation system conveying feature capability information;

FIG. 5 is a networked environment, where a system according to embodiments may be implemented;

FIG. 6 is a block diagram of an example computing operating environment, where embodiments may be implemented; and

FIG. 7 illustrates a logic flow diagram for exchanging feature capability information in a multi-modal communication system according to embodiments.

### DETAILED DESCRIPTION

As briefly described above, the nature of collaboration and the quality of interaction may be enhanced through exchange of feature capability information in multi-modal conversation systems. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for managing multi-modal conversations. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A “conversation” as used herein refers to a single modal or multi-modal communication between users. The conversation may include modalities such as audio/video/text communications, application sharing, file sharing, whiteboard sharing, and comparable modes. The conversation may be in real time, with time delay, or both. Furthermore, the conversation may be between two or more users. As discussed in more detail below, the conversation may be facilitated by endpoints, which may be implemented as software, hardware, or a combination of both. One or more communication networks may be utilized to facilitate the conversation. Aspects of the conversation may be managed and facilitated in a central manner by one or more servers or in a distributed manner by two or more endpoints and/or servers.

“Feature capabilities” as used herein refers to capabilities of collaborative systems facilitating conversations and/or capabilities of endpoints. Feature capabilities may include available modalities of conversation, but also specific features associated with distinct modalities. User interfaces of endpoints may reflect different feature capabilities and be adjusted based on available or used feature capabilities as discussed in more detail below.

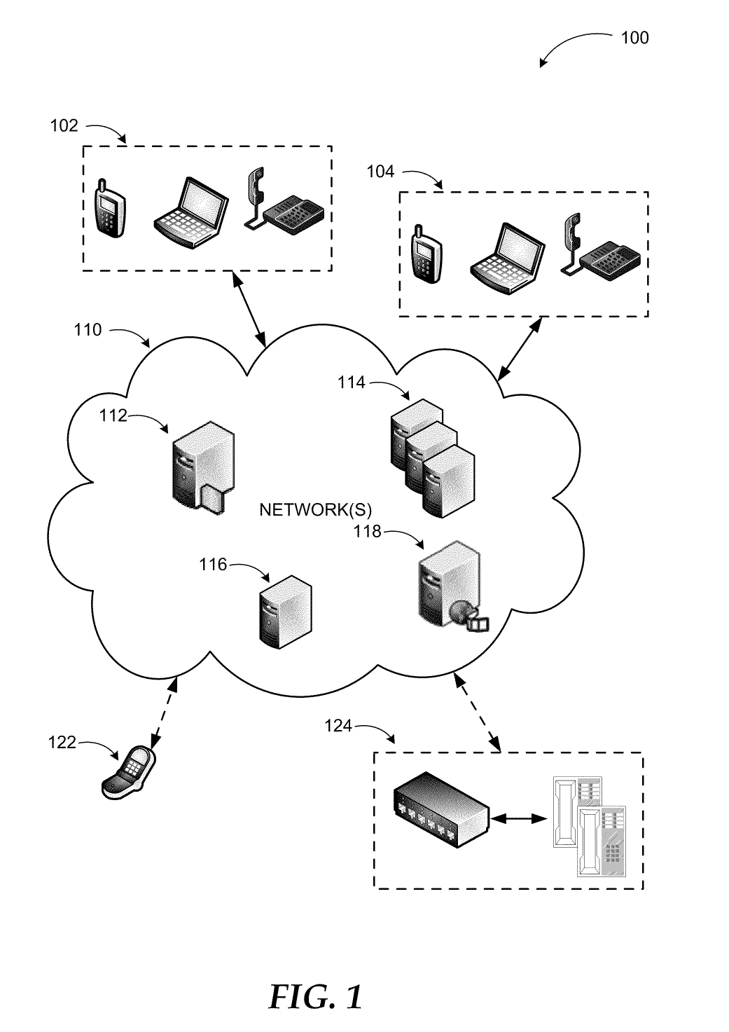

Referring to FIG. 1, diagram 100 of an example unified communications system, where embodiments may be practiced, is illustrated. A unified communication system is an example of modern communication systems with a wide range of capabilities and services that can be provided to subscribers. A unified communication system is a real-time communications system facilitating instant messaging, presence, audio-video conferencing, web conferencing functionality, and comparable capabilities.

In a unified communication (“UC”) system such as the one shown in diagram 100, users may communicate via a variety of end devices (102, 104), which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through PBX 124 to a Public Switched Telephone Network (“PSTN”). End devices may include any type of smart phone, cellular phone, any computing device executing a communication application, a smart automobile console, and advanced phone devices with additional functionality.

UC Network(s) 110 includes a number of servers performing different tasks. For example, UC servers 114 provide registration, presence, and routing functionalities. Routing functionality enables the system to route calls to a user to anyone of the client devices assigned to the user based on default and/or user set policies. For example, if the user is not available through a regular phone, the call may be forwarded to the user's cellular phone, and if that is not answering a number of voicemail options may be utilized. Since the end devices can handle additional communication modes, UC servers 114 may provide access to these additional communication modes (e.g. instant messaging, video communication, etc.) through access server 112. Access server 112 resides in a perimeter network and enables connectivity through UC network(s) 110 with other users in one of the additional communication modes. UC servers 114 may include servers that perform combinations of the above described functionalities or specialized servers that only provide a particular functionality. For example, home servers providing presence functionality, routing servers providing routing functionality, rights management servers, and so on. Similarly, access server 112 may provide multiple functionalities such as firewall protection and connectivity, or only specific functionalities.

Audio/Video (A/V) conferencing server 118 provides audio and/or video conferencing capabilities by facilitating those over an internal or external network. Mediation server 116 mediates signaling and media to and from other types of networks such as a PSTN or a cellular network (e.g. calls through PBX 124 or from cellular phone 122). Mediation server 116 may also act as a Session Initiation Protocol (SIP) user agent.

In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a commonly used method.

SIP is an application-layer control (signaling) protocol for creating, modifying, and terminating sessions with one or more participants. It can be used to create two-party, multi-party, or multicast sessions that include Internet telephone calls, multimedia distribution, and multimedia conferences. SIP is designed to be independent of the underlying transport layer.

SIP clients may use Transport Control Protocol (“TCP”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real-time Transport Protocol (“RTP”).

In a system according to embodiments, client applications may be enabled to exchange feature capability information through SIP (or another protocol) and decide which set of features are to be utilized for a conversation. A conversation identifier may be employed by the clients to keep track of utilized feature capabilities for a given conversation. According to other embodiments, a centralized control system may be employed, where a server or an MCU initiates the exchange of feature capability information and the decision making process. Of course, a combination of the centralized and distributed versions may also be used in some embodiments.

While the example system in FIG. 1 has been described with specific components such as mediation server, A/V server, and similar devices, embodiments are not limited to this system of the example components and configurations. A service for conveying feature capability information in a conversation may be implemented in other systems and configurations employing fewer or additional components.

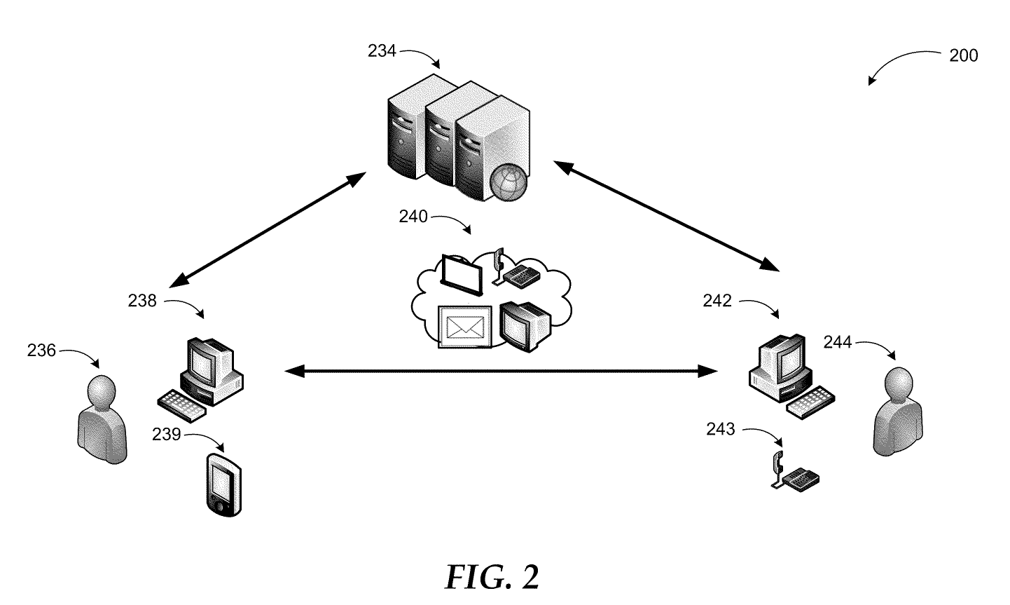

FIG. 2 includes conceptual diagram 200 illustrating a basic example system for a two-party conversation, where feature capability information may be exchanged before and during a communication session. While a system according to embodiments is likely to include a number of servers, client devices, and services such as those illustratively discussed in FIG. 1, only those relevant to embodiments are shown in FIG. 2.

As mentioned previously, a conversation between two or more users in an enhanced communication system such as a UC system may be facilitated through multiple devices/applications with varying communication capabilities. In a UC system for communication between endpoints, a calling party 236 initiates a conversation session by sending an invite to the called party 244. Calling party 236 may initiate the session from a variety of devices (238, 239) with different capabilities. Similarly, called party 244 may potentially accept the invite from a number of different devices/applications or endpoints (242, 243). The capabilities may also vary between different versions of communication applications. For example, one version of a particular application may support automatic interaction with user's calendar application enabling import and export of appointments and other calendar items during a multi-modal conversation (e.g. scheduling of new meetings as a result of the discussion in the conversation) while another version does not.

Knowledge of feature capabilities of participants/invitees to a conversation, specifically end-user features may enable adjustment of user interfaces for the participants and enhance the nature of collaboration and communication environment. Information on what other on-line users are capable of generally improves the quality of the end user interaction by informing them of the limitations of how they can interact with another specific user. Without communicating these capabilities upon initial setup of a session, one user may not be able know whether requests to interact with another user using a particular capability may succeed or fail. Less effective alternatives include trying and hoping for the best (learning remote party's capabilities based on failure events) and making a best guess based on communication through other channels. Neither approach is precise nor expedient as a solution that explicitly broadcasts deployed capabilities. Other, non-real-time approaches, such as periodically broadcasting capabilities through other (e.g. presence) channels lack the immediacy and benefit of knowing at all times what another user is capable of.

In addition to the examples discussed above, feature capabilities may include, but are not limited to, the ability to request control in application sharing session, ability to employ high definition video, ability to process multiple parallel video streams, and comparable ones. Embodiments provide an end-to-end mechanism to convey such information to both the initiating party and the invited party in real-time as the invite is routed.

One or more communication servers 234 may facilitate the conversation between the client applications providing communication UIs to calling party 236 and called party 244. The conversation session 240 may employ a single mode or be multi-modal. In case of multi-modal conversations, each modality within the conversation may be managed by a different server such as a file server for file exchanges, an A/V server for managing audio/video communications, an email server for managing exchange of emails or instant messages, and so on. Examples of modalities include, but are not limited to, text messaging, audio conversation, video conferencing, white-boarding, file transfer, application sharing, and comparable ones.

A capability framework according to embodiments enables conversation participants to convey capabilities corresponding to a particular channel (e.g. a video channel) within a modality, as well as higher-level capabilities outside the scope of one particular channel but still applies to the session.

Feature capabilities may be conveyed using any communication protocol employed by the communication system. SIP has been given as an example previously. Another example protocol is Session Description Protocol (SDP). SDP is intended for describing multimedia communication sessions for the purposes of session announcement, session invitation, and parameter negotiation. SDP does not deliver media itself but is used for negotiation between endpoints of media type, format, and all associated properties. The set of properties and parameters are often called a session profile. SDP is extensible to support new media types and formats. Other example protocols may include RTP and Remote Desktop Protocol (RDP).

According to one embodiment, some of the feature capabilities may be placed under an “m=” line. These capabilities may be referred to as sub-capabilities, since modality capability is implied by the “m=” line itself and any capability within that modality can be considered to exist solely within the scope of the modality. Other feature capabilities may be placed above the “m=” lines in an SDP, at the session level being applicable to the whole session as opposed to individual modalities. An example portion of a protocol is listed below:

a=capabilities: call-forward=”none” <session-capability>
m=video
a=capabilities: pause=”none” < sub-capability>
m=appsharing
a=capabilities: request-control=”both” < sub-capability>

The capability attributes may be provided in the format a=capabilities: <capability-1>=<mode><capability-2>=<mode> . . . <capability-n>=<mode>, where <capability-x>refers to a session level or modality level capability, and <mode>refers to implementation of the respective capability in accordance with a predefined schema. For example, <mode>may have values like “none” (not applicable to any participant), “render” (render capability), “capture” (capture a capability of invited participant), “both” or “all” (applicable to both—in case of two-party conversation—or all—in case of multi-party conversation—participants), and similar ones.

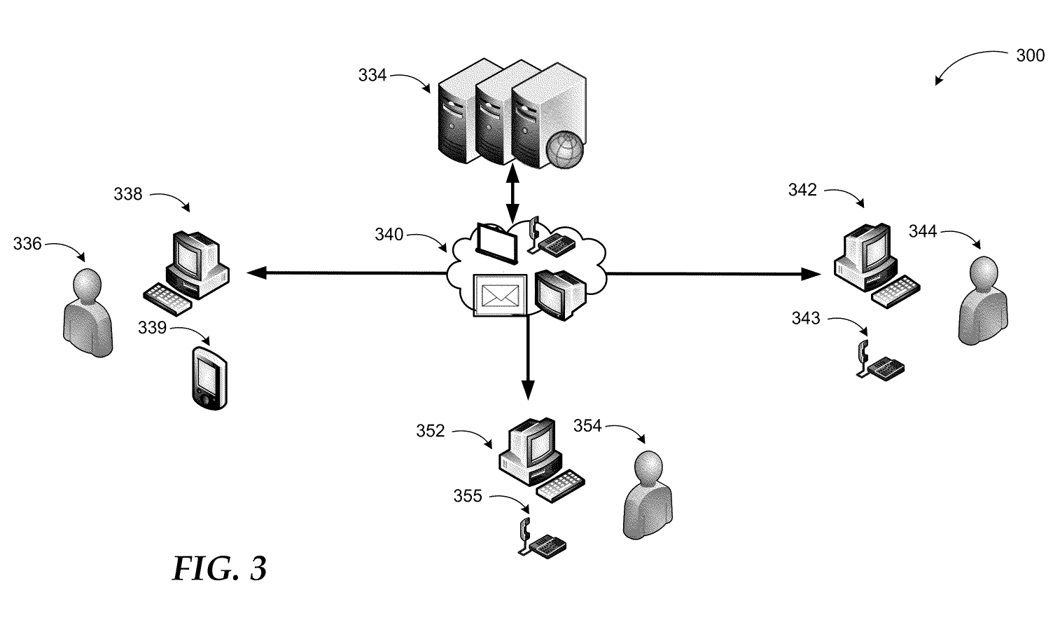

FIG. 3 includes conceptual diagram 300 illustrating a basic example system for a multi-party conversation, where feature capability information may be exchanged before and during a communication session. As shown in diagram 300, feature capability exchange in a conversation may also be employed in multi-party conversations.

In the example system shown in diagram 300, participants 336, 344, and 354 participate in multi-modal conversation 340 through one or more of their devices 338/339, 342/343, and 352/355 respectively. Aspects of the conversation may be managed by one or more servers 334. As discussed above, feature capabilities may be conveyed while the conversation is being established and/or when the conversation is being facilitated to update user interfaces in response to any changes. When the conveyed capability information is received by all participants, a decision may be made as to the common feature capability set to be employed in the conversation. The conveyance of the information and the decision may be managed in a distributed manner by the participating endpoints or in a central manner by the server(s) 334. In case of central control, individual endpoints may convey their information to the servers) 334 (e.g. an MCU) on their own initiative or upon request. The controlling entity may then include the capabilities in the conference event package. Of course, a combination of the central and distributed control mechanisms may also be employed for different aspects of feature capabilities such as detection of capabilities and decision making on the common set of capabilities to be used.

In addition to being based on device/application capabilities, system/resource availability, and organization policies, the feature capabilities may also be selected based on user credentials, permission levels, and/or privacy policies. For example, certain application sharing or recording features may be limited to select participants. In that case, the presence of a participant without required credentials may result in revocation of such capabilities (before or during the conversation if the “not-allowed” participant joins the conversation later).

A system according to embodiments may also be configured to remember capabilities of participants and adjust user interfaces within a given conversation session or in a persistent manner (future sessions for the same participants). As described above, feature capabilities may be conveyed as individual attributes (session level or modality level). According to some embodiments, versioning may be employed to convey capabilities as well.

Versioning essentially provides a set of feature capabilities with a single description instead of a list of individual capabilities. The version of a communication application may convey to other applications what capabilities that application possesses. An application receiving version information about another application may be configured to know that information or look it up at a database. An example of feature capability information conveyance through versioning is provide below:

m=appsharing
a=capabilities: appsharing.version=”<major>.<minor>”

where “<major>.<minor>” values may be alphanumeric characters defining the version of the particular application sharing system to be used.

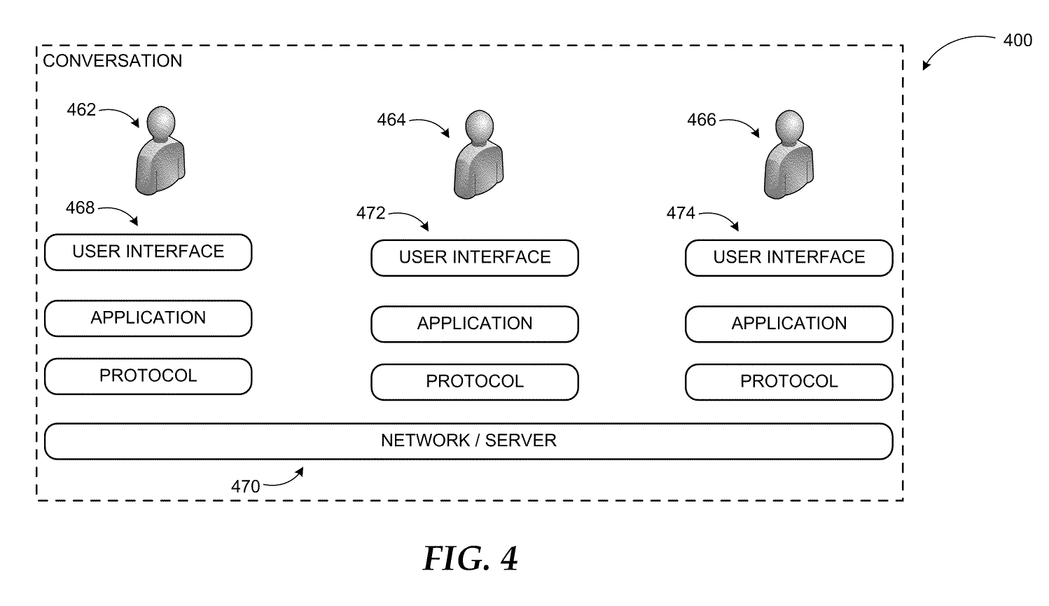

FIG. 4 illustrates architectural stack of major components in a conversation system conveying feature capability information. Diagram 400 is a conceptual illustration of a conversation with three participants. Network/server 470 provides the framework for the conversation and enables communication among participants employing a predefined protocol such as SIP. Each participant 462, 464, 466 is associated with respective protocol, application, and user interface layers 468, 472, 474. The participants may employ various devices to execute their applications on. The protocol layers enable communication over the common medium even if the applications have different capabilities (e.g. different versions). User interfaces for each respective application may also be distinct depending on application capabilities, device capabilities, user preferences, organization policies, and the like. For example, members of an organization may be permitted different modes of communication depending on their credentials (e.g. managers may be allowed to have video conference capability while others are not).

According to an example scenario, participant 462 may invite participants 464 and 466 to the conversation. In a system according to embodiments, capabilities of participants 464 and 466 may be conveyed to participant 462 pre-conversation or in-conversation. In the first mode, the entities may discover each other's capabilities for their respective endpoints while the conversation is being established and have that reflected in their respective user interfaces. According to the second mode, any changes in capabilities may be conveyed among the participants while the conversation is in progress and any changes reflected in the user interfaces.

According to another example scenario, participant 462 may indicate to participants 464 and 466 that “call transfer” feature is disabled while the conversation is being established through the used protocol. The applications for participants 464 and 466 may disable their “call transfer” functionality upon accepting the conversation invite and make appropriate changes in their respective user interfaces (e.g. hide the call transfer icon, make the call transfer icon transparent, etc.). This enables participant 462 to control the end feature set seen by participants 464 and 466.

While many communication modes and capabilities may be employed during an established conversation, example ones are described above for illustration purposes. The scenarios, example systems, conversation modes, features, and configurations discussed herein are for example purposes, and do not constitute limitations on embodiments. Other forms of communications, configurations, capabilities, and scenarios may be used in implementing a conversation system with feature capability exchange and selection in a similar manner using the principles described herein. Furthermore, the capabilities may also be conveyed using other protocols and formats.

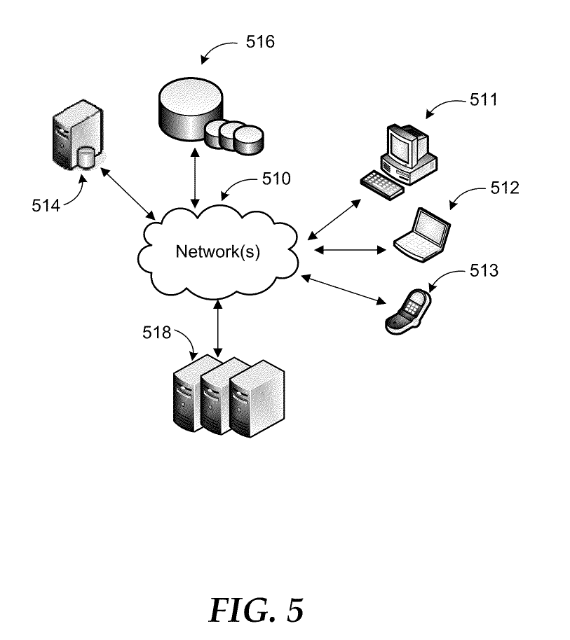

FIG. 5 is an example networked environment, where embodiments may be implemented. A platform providing multi-modal conversation services with feature capability exchange and selection during a conversation may be implemented via software executed over one or more servers 518 such as a hosted service. The platform may communicate with client applications on individual computing devices such as a cellular phone 513, a laptop computer 512, and desktop computer 511 ('client devices') through network(s) 510.

As discussed above, modern communication technologies such as UC services enable subscribers to utilize a wide range of computing device and application capabilities in conjunction with communication services. This means, subscribers may use client devices and applications with varying feature capabilities. Furthermore, environmental conditions (network load, etc.), organization policies, user preferences may also determine available or allowed feature capabilities. Thus, feature capabilities of individual users may be exchanged when the conversation is established and updated during the conversation if changes occur. A decision may be made in a distributed or centralized manner to determine the set of feature capabilities to be used in the conversation and client devices/applications accordingly configured.

Client devices 511-513 are used to facilitate communications through a variety of modes between subscribers of the communication system. One or more of the servers 518 may enable client applications to exchange available and/or allowed feature capabilities. Information associated with subscribers and facilitating communications with multi-modal escalation may be stored in one or more data stores (e.g. data store 516), which may be managed by any one of the servers 518 or by database server 514.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Furthermore, network(s) 510 may include short range wireless networks such as Bluetooth or similar ones. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a conversation system with feature capability exchange. Furthermore, the networked environments discussed in FIG. 4 are for illustration purposes only. Embodiments are not limited to the example applications, modules, or processes.

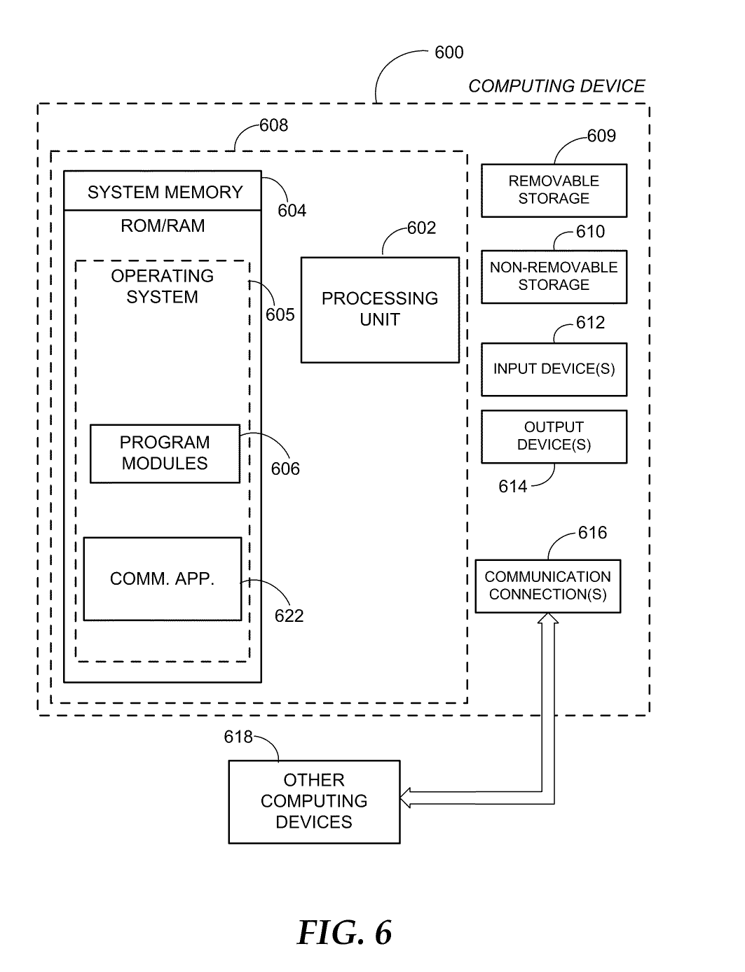

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a client device executing a communication application as part of an enhanced communication system and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606 and communication application 622.

Communication application 622 may be part of a service that facilitates conversation(s) through various modalities between client applications, servers, and other devices. Communication application 622 may determine feature capabilities associated with computing device 600 and itself, convey them to other participants of the conversation and adjust a user interface based on a decided set of feature capabilities to be used in the conversation as discussed previously. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, other directory or policy servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

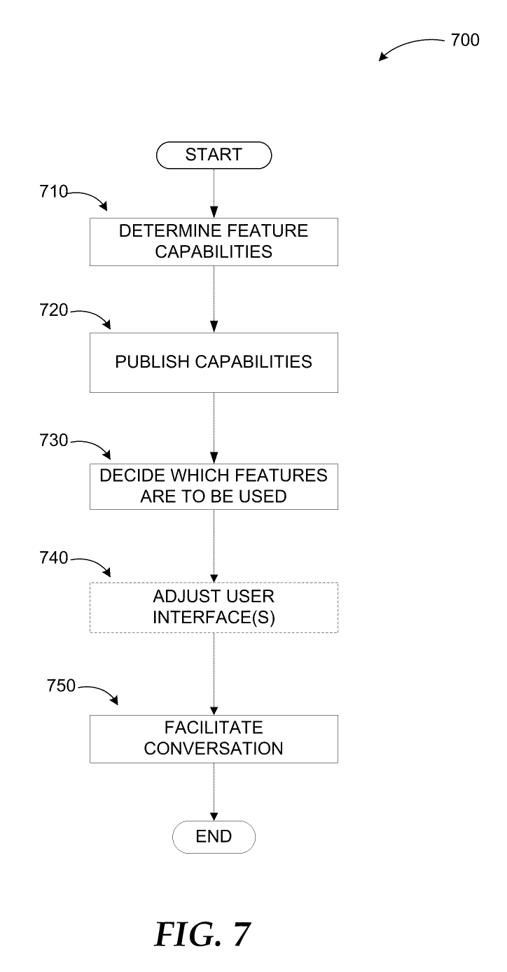

FIG. 7 illustrates a logic flow diagram for process 700 of exchanging feature capability information in a multi-modal communication system according to embodiments. Process 700 may be implemented as part of a communication system that facilitates multi-modal conversations.

Process 700 begins with operation 710, where feature capabilities of client devices and/or applications of participants in a conversation to be established are determined This may be done by the individual client applications or in response to a request from a centralized controller such as a server or an MCU. At operation 720, the feature capabilities are published such that different capabilities of participants can be compared and a common set of feature capabilities (available and/or allowed) can be determined. The feature capabilities may be conveyed as a list of individual capabilities in the SIP protocol (or another protocol) or as a version of the client applications using a version identifier according to e predefined schema. Again, the exchange of the feature capability information may be performed in a distributed manner by the individual client applications (endpoints) or by the central controller.

At operation 730, a decision is made which common feature capability set is to be utilized in the conversation. The decision may be based on available endpoint device characteristics, endpoint application characteristics, system capabilities, system resource availabilities (network capacity, etc.), organization policies, and/or user credentials. The decided feature capabilities may be conveyed to the client applications (or decision made at the client applications locally), which may adjust their user interfaces at optional operation 740. Adjustment of the user interfaces may include hiding, graying (or making transparent), rendering inoperable, or adding a new control element to the respective user interfaces. Such control elements may include, but are not limited to, graphical elements, textual elements, new windows, pop-up windows, hovering windows, and similar ones.

At operation 750, the conversation is established utilizing the selected set of common feature capabilities. If a change occurs during the conversation such as system conditions changing, an organizational policy rule becoming effective (e.g. a time based rule allowing certain modalities of conversation), a participant activating or deactivating another client device or a peripheral device, a permission status change, and comparable ones, the changed feature capabilities may be conveyed again in real time and a new decision made. Participants may then be updated with the new set of selected feature capabilities.

The operations included in process 700 are for illustration purposes. A communication service with feature capability exchange may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for conveying feature capability in a conversation facilitated by an enhanced communication system, the method comprising:
determining feature capabilities associated with an endpoint;
providing the feature capabilities to at least one other endpoint to participate in the conversation;
selecting a common set of feature capabilities to be employed in the conversation;
adjusting user interfaces of the endpoints based on the selected feature capabilities; and
establishing the conversation using the selected feature capabilities.

2. The method of claim 1, further comprising:
determining a change in the feature capabilities associated with at least one of the endpoints participating in the conversation;
modifying the selected set of feature capabilities based on the change; and
adjusting the user interfaces of the participating endpoints while the conversation is being facilitated.

3. The method of claim 1, wherein the feature capabilities are associated with at least one from a set of: an endpoint device, an endpoint application, a system capability, a system resource availability, an organization policy, and a user credential.

4. The method of claim 1, wherein the common set of feature capabilities is selected in a distributed manner by the participating endpoints.

5. The method of claim 1, wherein the common set of feature capabilities is selected in a central manner by a server managing the conversation.

6. The method of claim 5, wherein the server managing the conversation provides information about the selected feature capabilities to the participating endpoints such that each endpoint adjusts its respective user interface.

7. The method of claim 1, wherein a portion of the feature capabilities applicable to an entire conversation session are provided as session level capabilities and another portion of the feature capabilities applicable to distinct modalities of the conversation are provided as modality level capabilities for respective modalities employing a communication protocol.

8. The method of claim 7, wherein the communication protocol includes one of:
Session Initiation Protocol (SIP), Session Description Protocol (SDP), Real-time Transport Protocol (RTP), and Remote Desktop Protocol (RDP).

9. The method of claim 1, wherein adjusting the user interfaces includes at least one from a set of:
hiding a control;
rendering a control inoperable; and
adding a new control.

10. The method of claim 9, wherein the control includes one of: a graphical element, a textual element, a new window, a pop-up window, and a hovering window.

11. The method of claim 1, further comprising:
saving at least one of selected feature capabilities and individual endpoint capabilities for use during the established conversation.

12. The method of claim 1, further comprising:
saving at least one of selected feature capabilities and individual endpoint capabilities for use in future conversations.

13. A communication system for facilitating multi-modal conversations with feature capability selection, the system comprising:
a plurality of endpoints configured to facilitate multi-modal communications employing Session Initiation Protocol (SIP), the endpoints performing actions including:
determine feature capabilities associated with each endpoint;
publish the feature capabilities to other endpoint invited to participate in the conversation;
select a common set of feature capabilities to be employed in the conversation;
adjust respective user interfaces based on the selected feature capabilities;
establish the conversation using the selected feature capabilities;
in response to a change associated with at least one of the endpoints participating in the conversation, determine the change in the feature capabilities;
modify the selected set of feature capabilities based on the change; and
adjust the respective user interfaces while the conversation is being facilitated.

14. The system of claim 13, further comprising a communication server configured to manage the conversation between the endpoints of the system, wherein the communication server controls the publishing of the feature capabilities and the selection of the common set of feature capabilities facilitating conveyance of feature capability information among the endpoints employing SIP.

15. The system of claim 13, wherein the feature capabilities are conveyed in SIP messages as a capability attribute and a value for the capability attribute, the value being selected among available options according to a predefined schema.

16. The system of claim 13, wherein the change in the feature capabilities is caused by at least one from a set of: a participant activating a new endpoint, a participant deactivating an existing endpoint, a participant adding a peripheral, a participant removing an existing peripheral, a programming change, a network condition change, an organization policy change, and a permission status change.

17. A computer-readable storage medium with instructions stored thereon for conveying feature capability in a conversation facilitated by an enhanced communication system, the instructions comprising:
determining feature capabilities associated with each endpoint attempting to participate in the conversation;
conveying the determined feature capabilities to other endpoints attempting to participate in the conversation;
selecting a common set of feature capabilities to be employed in the conversation, wherein the common set of feature capabilities are selected based on at least one from a set of: endpoint device characteristics, endpoint application characteristics, a system capability, a system resource availability, an organization policy, and a user credential;
adjusting user interfaces of the endpoints based on the selected feature capabilities;
establishing the conversation using the selected feature capabilities;
determining a change in the feature capabilities associated with at least one of the endpoints participating in the conversation;
modifying the selected set of feature capabilities based on the change; and
conveying the changed set of feature capabilities to participating endpoints such that respective user interfaces of the participating endpoints are adjusted while the conversation is being facilitated.

18. The computer-readable medium of claim 17, wherein the feature capabilities are conveyed employing a version identifier for respective endpoints.

19. The computer-readable medium of claim 18, wherein the endpoints are configured to determine the conveyed feature capabilities through one of: preprogrammed information associated with the version identifier and retrieving feature capability information from a database based on the conveyed version identifier.

20. The computer-readable medium of claim 17, wherein the conversation is multi-modal and the modalities include at least one from a set of: a voice communication, a video communication, a white-boarding session, a data sharing session, an application sharing session, a text messaging session, and an email exchange.
